(19) United States
(12) Patent Application Publication
(10) Pub. No.: US 2025/0331023 A1
(43) Pub. Date: Oct. 23, 2025

(54) CARRIER SENSE MULTIPLE ACCESS (CSMA) WITH ENHANCED COLLISION AVOIDANCE

(71) Applicant: MaxLinear, Inc., Carlsbad, CA (US)

(72) Inventor: Sigurd Schelstraete, Menlo Park, CA (US)

(73) Assignee: MaxLinear, Inc., Carlsbad, CA (US)

(21) Appl. No.: 19/186,476

(22) Filed: Apr. 22, 2025

Related U.S. Application Data
(60) Provisional application No. 63/637,257, filed on Apr. 22, 2024.

(51) Int. Cl. H04W 74/0816

(52) U.S. Cl. CPC H04W 74/0816

(57) ABSTRACT

A station (STA) may include a processing device. The processing device may perform, at the STA, an arbitration inter-frame spacing (AIFS) backoff. The processing device may perform, at the STA, a carrier-sense multiple access (CSMA) contention window (CW) backoff. The processing device may send, at the STA, a first short signal when reaching a CSMA CW backoff end. The processing device may perform, at the STA, a first short backoff after sending the first short signal. The processing device may send, at the STA, a frame after an nth short signal has been sent and an nth short backoff has occurred in which n is an integer greater than or equal to 2.

### RELATED APPLICATION

This application claims the benefit of U.S. Provisional Application No. 63/637,257, filed Apr. 22, 2024, the disclosure of which is incorporated herein by reference in its entirety.

The examples discussed in the present disclosure are related to communications technology, and more specifically, to collision avoidance.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi®. Carrier-sense multiple access (CSMA) is a medium access control (MAC) protocol in which a node verifies the absence of other traffic before transmitting on a shared transmission medium.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a station (STA) may include a processing device. The processing device may perform, at the STA, an arbitration inter-frame spacing (AIFS) backoff. The processing device may perform, at the STA, a carrier-sense multiple access (CSMA) contention window (CW) backoff. The processing device may send, at the STA, a first short signal when reaching a CSMA CW backoff end. The processing device may perform, at the STA, a first short backoff after sending the first short signal. The processing device may send, at the STA, a frame after an nth short signal has been sent and an nth short backoff has occurred in which n is an integer greater than or equal to 2.

In some examples, a method may include one or more of: performing, at a station (STA), an AIFS backoff; performing, at the STA, a carrier-sense multiple access (CSMA) contention window (CW) backoff; sending, at the STA, a first short signal when reaching a CSMA CW backoff end; performing, at the STA, a first short backoff after sending the first short signal; sending, at the STA, a second short signal after the first short backoff; performing, at the STA, a second short backoff after sending the second short signal; and sending, at the STA, a frame after the second short backoff.

In some examples, a STA may include a processing device. The processing device may perform, at the STA, an AIFS backoff. The processing device may perform, at the STA, a carrier-sense multiple access (CSMA) contention window (CW) backoff. The processing device may perform, at the STA, a collision resolution operation. The processing device may send, at the STA, a frame after the collision resolution operation.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of carrier sense multiple access (CSMA).

FIG. 2 illustrates an example of CSMA collision avoidance.

FIG. 3 illustrates an example of enhanced distributed channel access (EDCA) medium contention.

FIG. 4 illustrates an example of collisions with carrier sense multiple access, collision avoidance (CSMA/CA).

FIG. 5 illustrates an example comparison of CSMA/CA and CSMA with enhanced collision avoidance.

FIG. 6 illustrates example collision resolution with CSMA with enhanced collision avoidance.

FIG. 7 illustrates example collision between a legacy system and a system using CSMA with enhanced collision avoidance.

FIG. 8 illustrates an example of transmit/receive (Tx/Rx) turnaround.

FIG. 9 illustrates an example process flow of CSMA with enhanced collision avoidance.

FIG. 10 illustrates an example process flow of a CSMA with enhanced collision avoidance.

FIG. 11 illustrates an example process flow of CSMA with enhanced collision avoidance.

FIG. 12 illustrates an example communication system of CSMA with enhanced collision avoidance.

FIG. 13 illustrates a diagrammatic representation of a machine in the example form of a computing device within which a set of instructions, for causing the machine to perform any one or more of the methods discussed herein, may be executed.

FIG. 14 illustrates example network throughput as a function of contending stations (STAs) for various access category (AC) values.

FIG. 15 illustrates example number of collisions as a function of contending STAs for various AC values.

FIG. 16 illustrates example throughput of access category best efforts (AC_BE) as a function of contention window maximum (CW max).

FIG. 17 illustrates example throughput of access category voice (AC_VO) and access category video (AC_VI) as a function of CW max.

FIG. 18 illustrates example throughput of AC_VO and AC_VI as a function of CW max.

FIG. 19 illustrates example throughput for a fixed contention window (CW).

FIG. 20 illustrates example optimal fixed CW as a function of number of contending STAs.

FIG. 21 illustrates example network throughput and collision percentage as a function of number of iterations.

FIG. 22 illustrates example network throughput as a function of contending STAs for various AC values.

FIG. 23 illustrates example network throughput as a function of contending STAs for various AC values.

FIG. 24 illustrates example number of collisions as a function of contending STAs for various AC values.

FIG. 25 illustrates example number of collisions as a function of contending STAs for various AC values.

FIG. 26 illustrates an example latency cumulative distribution function for low latency (LL) traffic.

FIG. 27 illustrates an example latency cumulative distribution function for LL traffic.

FIG. 28 illustrates an example latency cumulative distribution function for LL traffic.

FIG. 29 illustrates an example latency cumulative distribution function for LL traffic.

FIG. 30 illustrates an example latency cumulative distribution function for LL traffic.

FIG. 31 illustrates an example latency cumulative distribution function for LL traffic.

FIG. 32 illustrates example network throughput for AC_VO.

FIG. 33 illustrates an example latency cumulative distribution function for LL traffic.

FIG. 34 illustrates an example latency cumulative distribution function for LL traffic.

FIG. 35 illustrates an example latency cumulative distribution function for LL traffic.

### DESCRIPTION

The basic medium access protocol of Institute of Electrical and Electronics Engineers (IEEE) 802.11 compliant systems is based on CSMA/CA (Carrier Sense Multiple Access with Collision Avoidance). As stated in the 802.11 standard:
“The CSMA/CA protocol is designed to reduce the collision probability between multiple STAs accessing a medium, at the point where collisions would most likely occur. Just after the medium becomes idle following a busy medium (as indicated by the CS function) is when the highest probability of a collision exists. This is because multiple STAs could have been waiting for the medium to become available again. This is the situation that necessitates a random backoff procedure to resolve medium contention conflicts.”

The CSMA/CA (or “DCF”) mechanism sets forth that stations (STAs) desiring to initiate transfer of data frames and/or management frames to determine the busy/idle state of the medium (i.e., ascertain whether a transmission is ongoing on the medium or not). After detecting that the medium is idle, the STA may defer for a standard-defined period of time before sending a transmission on the medium. This pre-defined period includes a fixed time period known as distributed (coordination function) interframe space (DIFS), followed by an additional deferral period based on a random value selected by the STA. The STA may select a random value within a given range (the contention window (CW)) and count down from this value while continuing to sense the medium. When the countdown reaches zero, the STA may be allowed to transmit on the medium. If during the countdown, the STA senses that the medium is busy, the STA may defer until after the detected transmission has ended and restart the backoff with the last value of its counter (the DIFS period backoff precedes this new countdown).

Examples of the present disclosure will be explained with reference to the accompanying drawings.

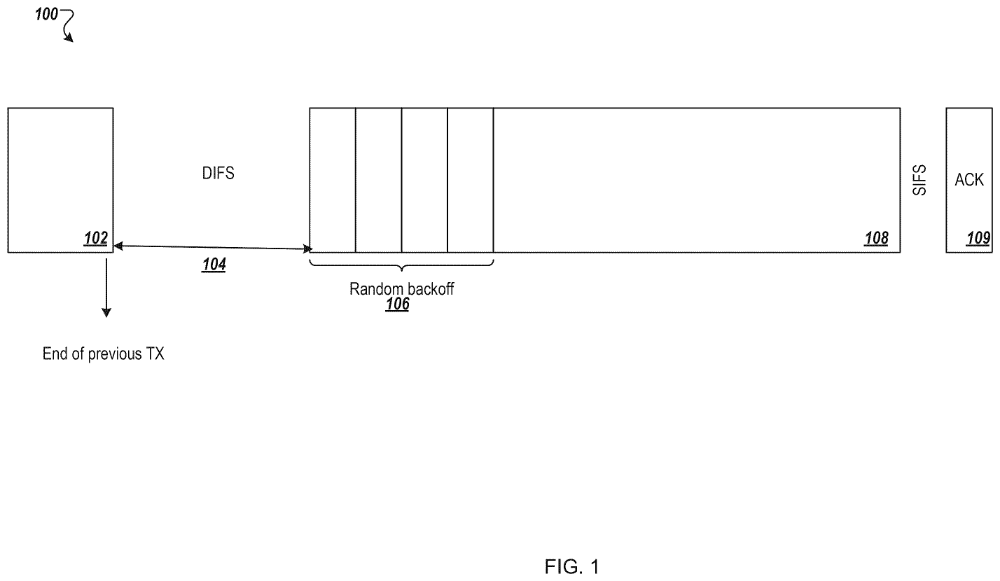

The operation of CSMA/CA is illustrated in the diagram 100 in FIG. 1. A previous transmission 102 may be followed by a fixed time period (e.g., DIFS 104). After the DIFS 104, a random backoff 106 may occur which may include a number of slots. After the random backoff 106 has occurred, the STA may transmit a transmission 108 which may be followed by a short interframe space (SIFS) and an acknowledgment (ACK) 109. Introducing a random countdown element (e.g., random backoff 106) may reduce the likelihood that two STAs may be waiting for the end of the active transmission to try to access the medium at the same time.

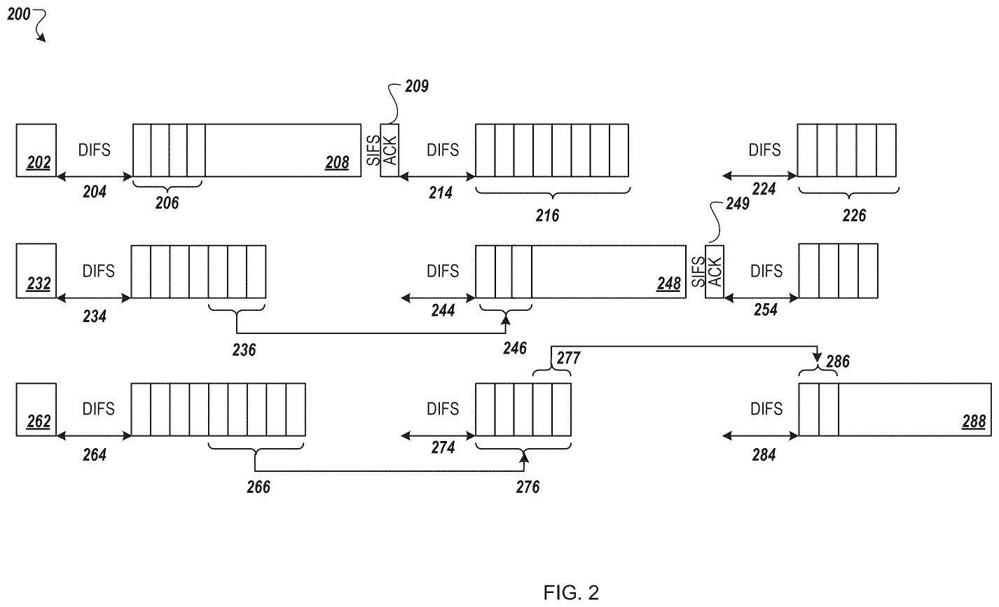

FIG. 2 illustrates in a diagram 200 how this collision avoidance works when different STAs are competing for the medium at the same time (i.e. after the end of the previous transmission).

For example, a first STA may have a previous transmission 202 that ends. The previous transmission 202 may be followed by a DIFS 204 and a random backoff 206 that may include a number of slots. A second STA may have a previous transmission 232 that ends which may be followed by a DIFS 234 and a random backoff including a number of slots. A third STA may have a previous transmission 262 that ends which may be followed by a DIFS 264 and a random backoff including a number of slots. The first STA may send a transmission 208 after the random backoff 206 has ended. The second STA may have a random backoff that has a longer duration than the random backoff 206. As a result, the second STA may have slots 236 that observe a collision with transmission 208. The third STA may have a random backoff that has a longer duration than the random backoff 206. As a result, the third STA may have slots 266 that observe a collision with a transmission 208. An SIFS and an ACK 209 may follow the transmission 208.

After the SIFS and the ACK 209, the first STA may have a DIFS 214, the second STA may have a DIFS 244, and the third STA may have a DIFS 274. The DIFS 214, DIFS 244, and DIFS 274 may be followed by random backoffs 216, 246, and 276, respectively. Because the random backoff 246 is shorter than the random backoff 216 and the random backoff 276, the second STA may gain access to the medium and transmit a transmission 248 followed by an SIFS and an ACK 249. The third STA may observe a collision with transmission 248 as indicated by the slots 277.

After the SIFS and the ACK 249, the first STA may have a DIFS 224, the second STA may have a DIFS 254, and the third STA may have a DIFS 284. The first STA may have a random backoff 226 that may exceed the random backoff for the third station, which may have a random backoff 286. Therefore, the third STA may gain access to the medium and may transmit a transmission 288.

The STAs for which the backoff counter has not reached zero may continue counting down from the latest value of the counter for the next contention. For example, the second STA may continue to countdown as shown by the correspondence between 236 and 246. Similarly, the third STA may continue to countdown as shown by the correspondence between 266 and 276 and the correspondence between 277 and 286.

Depending on the number of active STAs trying to access the medium, it may remain statistically possible that multiple STAs may access the medium at the same time, simply because the number of distinct random backoff values may be limited. To address this, CSMA also specifies that if STAs observe a collision (based on the absence of an acknowledgement to their transmission), the STAs may increase (e.g., double) the contention window (CW) for the next medium contention. This increases the range of random values used by the contending STAs and reduces the overall collision probability. Once a STA is able to complete a successful transmission, the CW may reset to its original value.

The CSMA/CA mechanism was later enhanced to accommodate services of different priority levels. This was done by adding four independent Enhanced Distributed Channel Access (EDCA) functions. Each of these functions contends for the medium independently using its own value for the fixed backoff (renamed AIFS) and its own contention window (CW). Higher priority services may use a smaller fixed backoff and a smaller contention window, which may give these services a higher probability of gaining access to the medium when competing with lower-priority services.

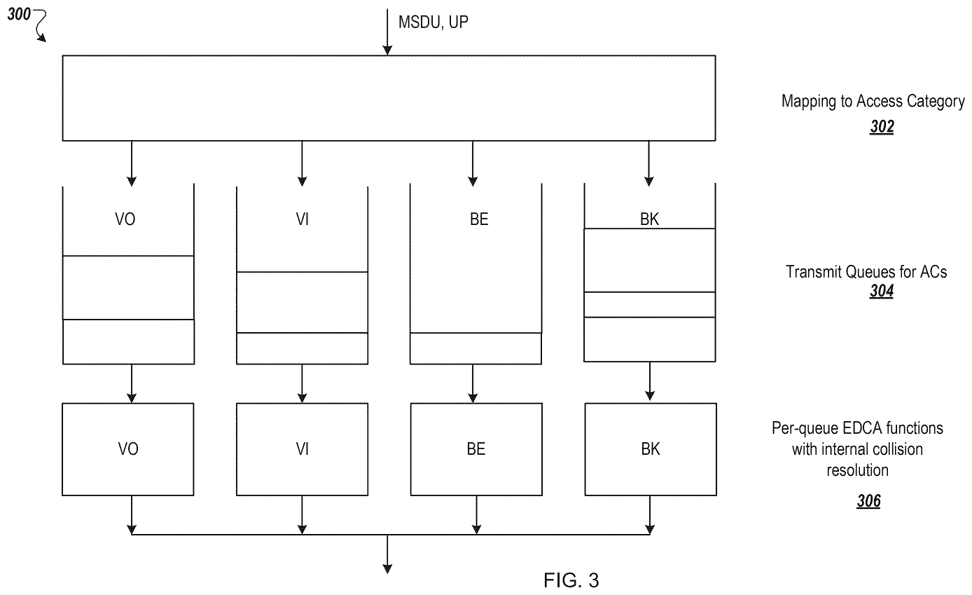

As illustrated in FIG. 3, EDCA medium contention may involve mapping a MAC service data unit (MDSU) to an access category, as shown in operation 302. Queues for the different access categories may be transmitted, as shown by operation 304. The different access categories may have per-queue EDCA functions with internal collision resolution, as shown by operation 306. The different access categories may include voice (VO), video (VI), best efforts (BE), and background (BK).

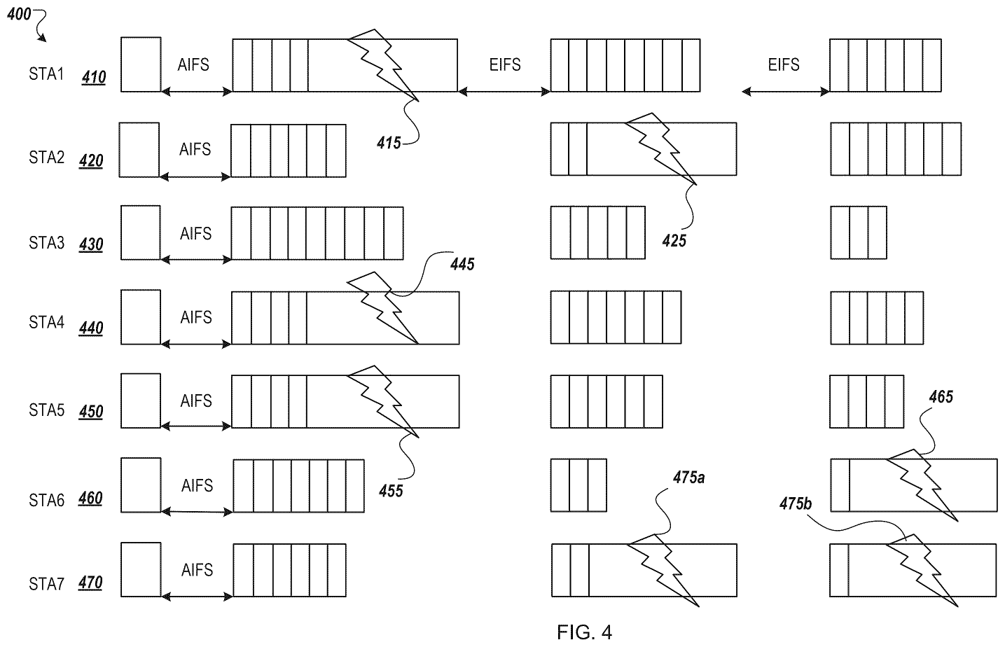

Even with the random backoff specified in CSMA/CA, collisions may remain a possibility. Even with random backoff, collisions may occur because multiple STAs may select the same random value. When the number of available random values is small compared to the number of contending STAs, collisions may become increasingly likely. As illustrated in the diagram 400 in FIG. 4, different STAs may have transmissions that collide with each other. STA1 410 may have a transmission 415 that may collide with a transmission 445 by STA4 440 and with a transmission 455 by STA5 450. STA2 420 may have a transmission 425 that may collide with a transmission 475a by STA7 470. STA6 460 may have a transmission 465 that may collide with a transmission 475b by STA7 470. STA3 430 may not have any collisions with the other STAs.

In EDCA, minimum and maximum values for the Contention Window may be specified per access category. The EDCA may specify AIFS and CW limits per AC. The ACs may effectively perform independent CSMA/CA. The values are shown in Table 1.

TABLE 1
EDCA parameters

| | Traffic | CW | CW | | AIFS |
|---|---|---|---|---|---|
| AC | Type | min | max | AIFSN | (μs) |
| AC_BK | Background | 15 | 1023 | 7 | 79 |
| AC_BE | Best Effort | 15 | 1023 | 3 | 43 |
| AC_VI | Video | 7 | 15 | 2 | 34 |
| AC_VO | Voice | 3 | 7 | 2 | 34 |

When multiple STAs are contending on a busy medium, the CW may be increased to avoid collisions. While this increase in CW may be designed to account for a busier medium, it has a number of drawbacks. Specifically: the CW may be increased for STAs that experience a collision, but does not move the whole network to a different CW. A collision event is relatively expensive as it means lost airtime for the full duration of the colliding transmissions. After a successful transmission, the transmitting STA may revert back to the original CW window, which may not be appropriate for the network overall. In highly congested networks, collisions may remain an issue and non-negligible airtime may be used to adjust the CW to bring down the collision probability.

CSMA/CA may be enhanced to reduce the chances of collision in a highly congested medium. CSMA/CA may be enhanced so that: (1) it is compatible with CSMA, (2) it does not have specific STAs behave differently from others, and (3) it does not increase CW when collisions happen.

A STA may include a processing device. The processing device may perform, at the STA, an AIFS backoff. The processing device may perform, at the STA, a CSMA CW backoff. The processing device may send, at the STA, a first short signal when reaching a CSMA CW backoff end. The processing device may perform, at the STA, a first short backoff after sending the first short signal.

The processing device may send, at the STA, a frame after a selected number of short signals have been sent and a selected number of short backoffs have occurred. In one example, the frame may be sent after 2 short signals have been sent and 2 short backoffs have occurred. In another example, the frame may be sent after 3 short signals have been sent and 3 short backoffs have occurred. In another example, the frame may be sent after 4 short signals have been sent and 4 short backoffs have occurred. The number of short signals to be sent may be selected based on the congestive nature of the network. The number of short signals to be sent may be increased when the congestion of the network increases.

The processing device may send, at the STA, the second short signal after the first short backoff. The processing device may perform, at the STA, a second short backoff after sending the second short signal. The processing device may send, at the STA, a third short signal after the second short backoff. The processing device may perform, at the STA, a third short backoff after sending the third short signal.

The processing device may terminate, at the STA, medium contention when the STA detects a clear channel assessment (CCA) value that is greater than a threshold CCA value. For example, at a selected threshold, the STA may determine that the medium is busy and may stop contention.

The short signal may be a suitable duration. In some cases, the short signal may be 8 microseconds. In another case, the short signal may be 24 microseconds. In another case, the short signal may be 40 microseconds. In some cases, the short signal may be one or more of a legacy short training field or a clear to send signal.

The short backoffs may have a duration that is less than an AIFS backoff duration. Having short backoffs that are less than AIFS backoff duration may maintain that the medium is busy.

The processing device may skip, at the STA, a transmission in a first slot after transmission of the first short signal to facilitate transmit-receive (Tx/Rx) turnaround.

The processing device may perform a collision resolution operation. The collision resolution operation may include sending one or more short signals and performing one or more short backoffs. The processing device may send, at the STA, a frame after the collision resolution operation.

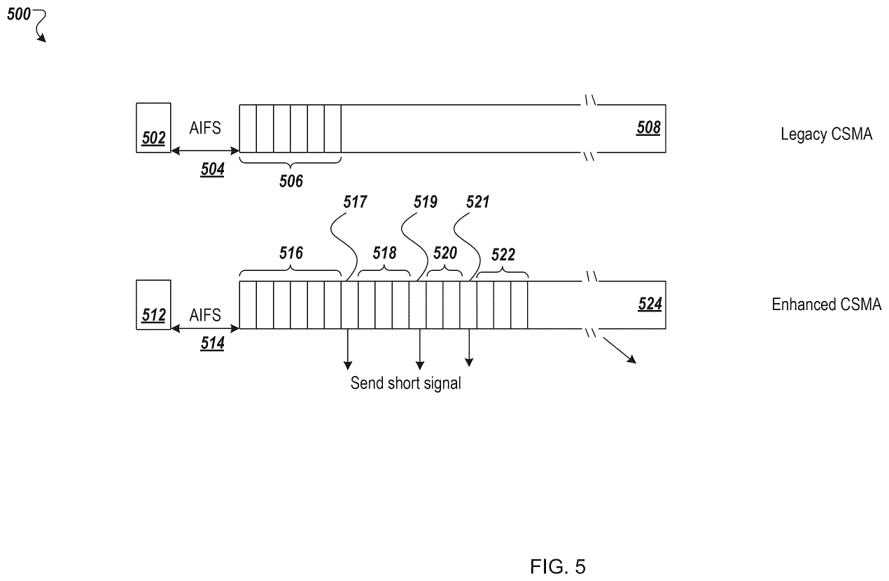

A comparison 500 of enhanced CSMA and legacy CSMA is illustrated in FIG. 5. In legacy CSMA, after a transmission 502, a fixed backoff AIFS 504 may occur. AIFS 504 may be followed by a random backoff 506. After the random backoff 506 has expired, the STA may transmit a transmission 508.

In enhanced CSMA, the first phase of medium contention may be identical to CSMA/CA. Specifically, the STAs may defer transmission after the end of the previous transmission by an amount of time that includes a fixed backoff (AIFS), followed by a variable backoff. That is, in enhanced CSMA, after a transmission 512 has occurred, a fixed backoff (e.g., AIFS 514) may be performed. The fixed backoff may be followed by a random backoff 516.

Upon gaining access to the medium a STA whose backoff counter has reached zero (there could be more than one) may transmit a short signal (e.g., short signal 517). This short signal 517 may be the legacy short training field (L-STF) of a regular 802.11 preamble (8 μs in length). This short signal 517 may be sufficient for other STAs that are still contending to understand that the medium is busy, causing them to end their contention. That is, the STAs may perform packet detect to determine that the medium is busy.

STAs whose backoff counter reached zero may now remain. Instead of moving on to the transmission of the pending frame as in CSMA, these “surviving” STAs may instead perform one or more additional short rounds of random backoff. That is, the short signal may be followed by another random backoff 518, which may be followed by another short signal 519, another random backoff 520, another short signal 521, and another random backoff 522 before a transmission 524 is transmitted. Note that none of the STAs may know whether there is more than one STA that gained access to the medium. The STAs may know that the end of the backoff counter was reached without observing a busy medium.

The subsequent round of random backoff may be short enough to not exceed the shortest AIFS period. This may prevent other STAs (not in the set of surviving STAs) from gaining access to the medium. During the countdown, STAs may continue to monitor the busy/idle state of the medium. Any STA that reaches the end of its backoff counter may again send a short signal. Any STA that observes a busy medium prior to reaching the end of the countdown may abandon its attempt to access the medium. Even though random backoff rounds are short, each round may likely reduce the number of surviving STAs. The number of short backoff rounds may be selected appropriately for the overall congestion state of the medium. After the end of the final short backoff round, STAs whose counter has reached zero may send the actual frame.

The short transmission may be sufficient for STAs to perform packet detect and recognize the medium as busy which may result in STAs ending their contention and leaving fewer STAs to contend in the next round. The initial rounds of contention may add overhead to the channel access. Therefore, the reservation signal may be designed to be short enough to avoid excess overhead. In some examples, the short signal may be the L-STF field of a regular 802.11 preamble (8 μs in length). In other examples, the short signal may be a clear to send (CTS) signal. In some examples, the minimum duration of the short signal may be 24 μs. In other examples, the duration of the short signal may be 40 μs.

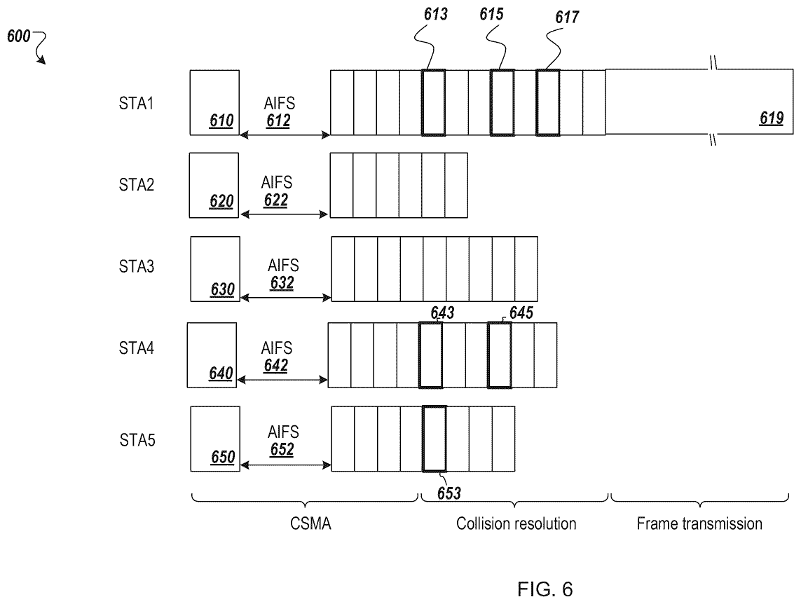

As illustrated in FIG. 6, enhanced CSMA may be used to reduce collisions. Five STAs (STA1, STA2, STA3, STA4, STA5) may contend for access to the medium. The STAs may perform an AIFS backoff as shown by AIFS 612, 622, 632, 642, and 652 after the previous transmissions 610, 620, 630, 640, 650. In this example, three STAs (e.g., STA1, STA4, and STA5) reach the end of the CSMA backoff at the same time. In legacy CSMA, this would result in a three-way collision and the loss of the three frames. Here, the three STAs (e.g., STA1, STA4, and STA5) send the short “busy” sequence (e.g., short signals 613, 643, 653) and only those three STAs (e.g., STA1, STA4, and STA5) move on to the subsequent short contention rounds. STA2 and STA3 observe a busy medium before the end of their countdowns and therefore end their contentions.

In the next round, two STAs (e.g., STA1 and STA4) may reach the end of their countdown at the same time and may send the short “busy” sequence (e.g., short signals 615 and 645). The other STA (e.g., STA5) may observe a busy medium before the end of its countdown. This STA (e.g., STA5) may end its contention.

In the next round, the two remaining STAs (e.g., STA1 and STA4) may perform another backoff round. In this case, STA1 may reach the end of its countdown first and STA4 may ends its contention when it observes the busy medium. From here on, STA1 may remain, and STA1 may eventually send a frame 619 onto the medium after sending short signal 617. Therefore, a situation that started with a potential collision of three STAs evolved into a situation where one STA (e.g., STA1) accesses the medium, thus avoiding collisions.

When the STAs attempt to access the medium, the STAs do not know when more than one STA has gained access to the medium. The STAs may observe that the STAs reached the end of their backoff counters without observing a busy medium. The number of rounds used to determine when a frame may be sent may be fixed (e.g., 2 round, 3 rounds, 4 rounds). The number of rounds used to determine when a frame may be sent may be adjusted to achieve a selected collision probability. In some examples, the STAs may not detect collisions.

Note that the probability of collisions may be reduced statistically. There may remain a non-zero chance that multiple STAs may be in a “tie” during all of the short backoff rounds. However, the probability of a tie may be reduced. First of all, the number of surviving STAs at the start of the collision resolution may be lower than the total number of competing STAs and secondly, the aggregate probability of colliding may be the product of the probabilities of collision during each round. This probability may go down exponentially.

Enhanced CSMA may be compatible with legacy CSMA in the sense that enhanced CSMA may perform like CSMA up to the point where channel access is gained. When a device has gained access, the behavior may be different. Instead of proceeding with the immediate transmission of a frame, a number of short signals are sent before the actual frame.

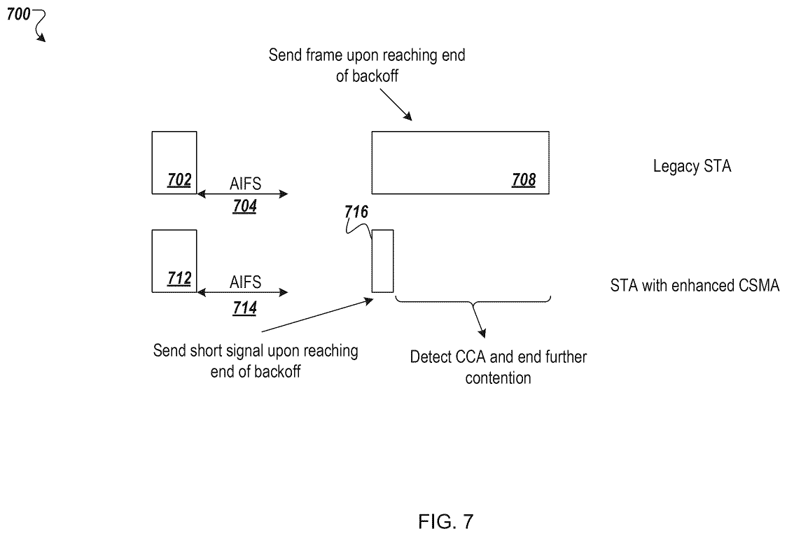

FIG. 7 illustrates what occurs when a “legacy” device is deployed together with a device that implements the new collision avoidance scheme when both devices try to access the medium at the same time. After a previous transmission 702 and a previous transmission 712, the legacy STA may perform AIFS 704 and the STA with enhanced CSMA may perform AIFS 714. The STA with enhanced CSMA may end its contention after detecting the medium is busy because the legacy STA may send a frame 708 and the STA with enhanced CSMA may detect clear channel assessment (CCA) and end further contention. Rather than a collision that affects the duration of the legacy frame (as shown in e.g. FIG. 4), the initial part of the preamble of the legacy transmission may be affected because the STA with enhanced CSMA may send a short signal 716 upon reaching end of backoff. This part of the packet may be more robust due to low modulation. This does not guarantee that the legacy packet may survive such a collision, but the impact of a STA with enhanced CSMA on a legacy device is less disruptive than the impact of another legacy device.

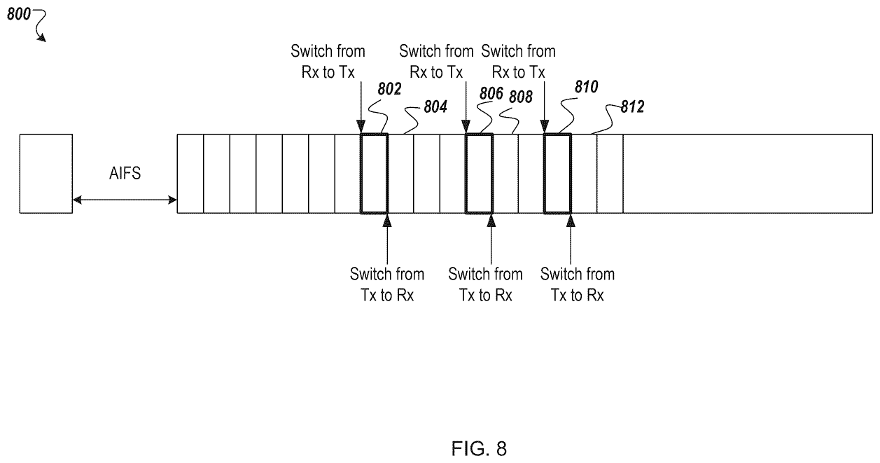

As illustrated in FIG. 8, the first slot after transmission of the short signal may be used for Tx/Rx turnaround. For example, the STA may switch from Rx to Tx, send a short signal 802, and switch from Tx to Rx after sending the short signal during the slot 804. Furthermore, the STA may switch from Rx to Tx before sending short signal 806, and switch from Tx to Rx during slot 808. Similarly, the STA may switch from Rx to Tx before sending the short signal 810, and switch from Tx to Tx during slot 812. There may be no transmissions in the first slot after transmission of the short signal. Tx/Rx turnaround (or Rx/Tx turnaround) may occur at various points in the channel access. The switch from Rx (listening mode) to Tx may be similar to what is used for devices that perform EDCA.

When switching from Tx to Rx during the “elimination rounds” when performing enhanced CSMA, the first slot following a slot where a device has transmitted its short signal may not be used to transmit the signal for the next short round. The slot immediately following the short transmission may be used for switching from Tx to Rx, to be ready for detecting in the next slot (second slot after short transmission).

In some examples, enhanced CSMA may be used to reduce latency by 25% for the 95^{th} percentile of the latency distribution compared to the Extremely High Throughput MAC/PHY operation. For a given scenario, implementations of the IEEE 802.11 standard may achieve multi-Gbps throughout, sub-10 ms latency and packet losses lower than 0.1%. While a new AC with CWₘᵢₙ<3 may in principle get higher priority than AC_VO, such an AC may be plagued by excessive collisions between services in the new AC. Time lost in collisions may eliminate or reverse any latency gains made from the lower channel access times. Combining the enhanced CSMA with an additional AC with selected channel access parameters may enhance priority for dedicated services and avoid penalty of collisions.

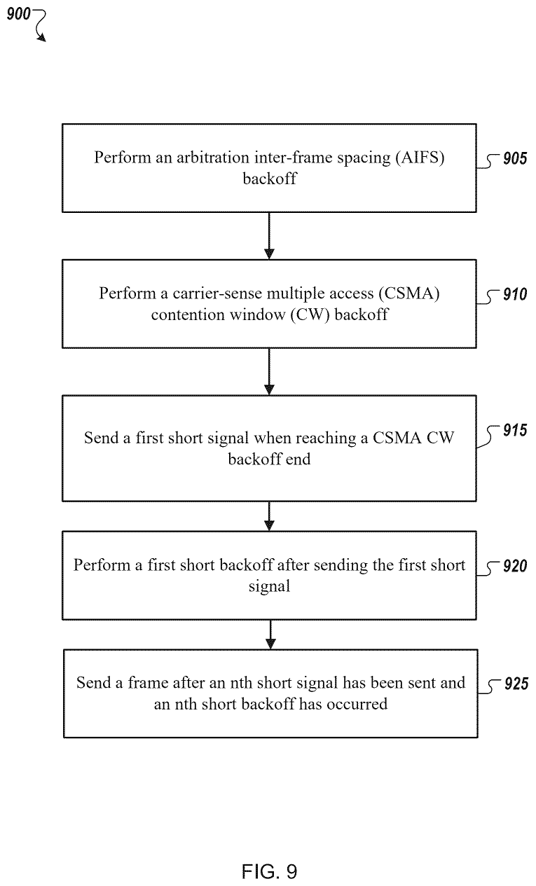

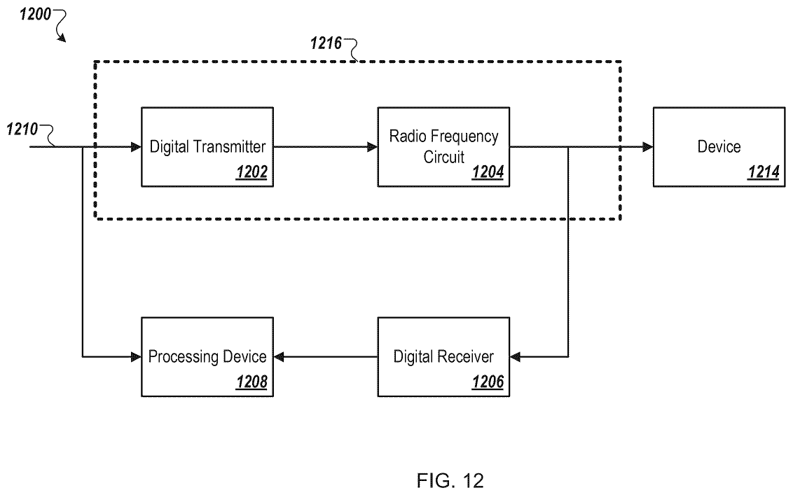

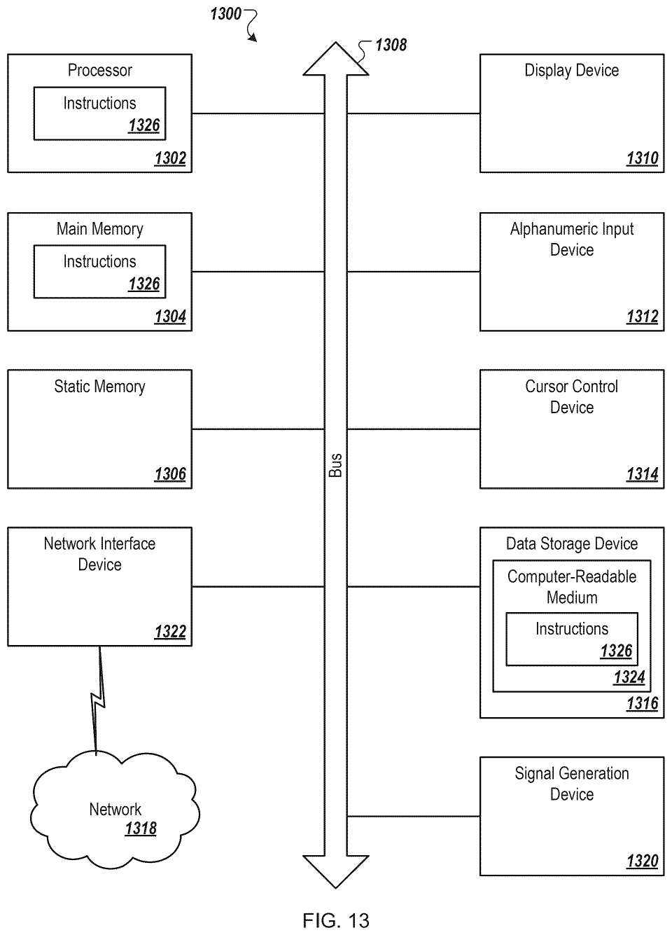

FIG. 9 illustrates a process flow of an example method 900 of CSMA with enhanced collision avoidance, in accordance with at least one example described in the present disclosure. The method 900 may be arranged in accordance with at least one example described in the present disclosure. The method 900 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 1200 of FIG. 12, or another device, combination of devices, or systems.

The method 900 may begin at block 905 where the processing logic may perform, at the STA, an AIFS backoff.

At block 910, the processing logic may perform, at the STA, a carrier-sense multiple access (CSMA) contention window (CW) backoff.

At block 915, the processing logic may send, at the STA, a first short signal when reaching a CSMA CW backoff end.

At block 920, the processing logic may perform, at the STA, a first short backoff after sending the first short signal.

At block 925, the processing logic may send, at the STA, a frame after an nth short signal has been sent and an nth short backoff has occurred in which n is an integer greater than or equal to 2.

Modifications, additions, or omissions may be made to the method 900 without departing from the scope of the present disclosure. For example, in some examples, the method 900 may include any number of other components that may not be explicitly illustrated or described.

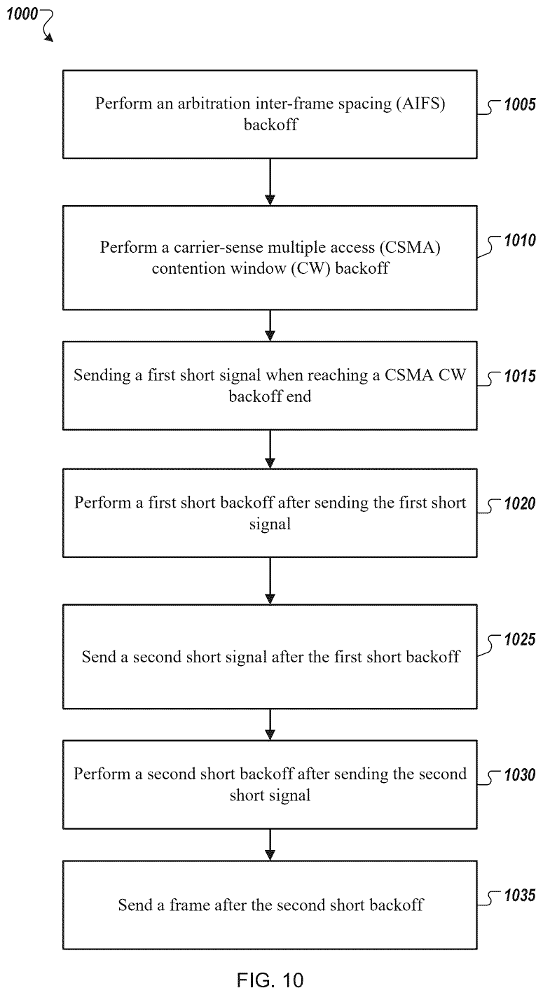

FIG. 10 illustrates a process flow of an example method 1000 that may be used for CSMA with enhanced collision avoidance, in accordance with at least one example described in the present disclosure. The method 1000 may be arranged in accordance with at least one example described in the present disclosure. The method 1000 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 1200 of FIG. 12, or another device, combination of devices, or systems.

The method 1000 may begin at block 1005 where the processing logic may perform, at a STA, an AIFS backoff.

At block 1010, the processing logic may perform, at the STA, a CSMA CW backoff.

At block 1015, the processing logic may send, at the STA, a first short signal when reaching a CSMA CW backoff end.

At block 1020, the processing logic may perform, at the STA, a first short backoff after sending the first short signal.

At block 1025, the processing logic may send, at the STA, a second short signal after the first short backoff.

At block 1030, the processing logic may perform, at the STA, a second short backoff after sending the second short signal.

At block 1035, the processing logic may send, at the STA, a frame after the second short backoff.

Modifications, additions, or omissions may be made to the method 1000 without departing from the scope of the present disclosure. For example, in some examples, the method 1000 may include any number of other components that may not be explicitly illustrated or described.

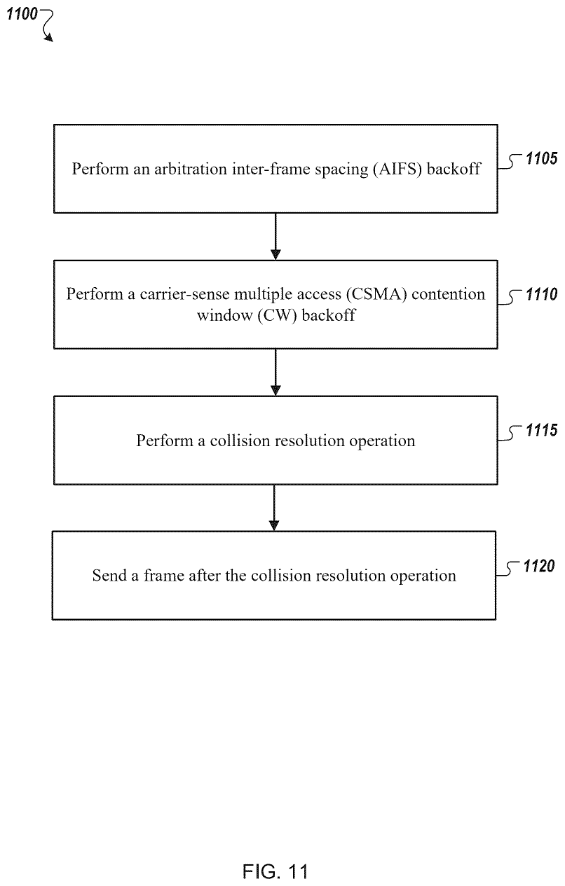

FIG. 11 illustrates a process flow of an example method 1100 that may be used for CSMA with enhanced collision avoidance, in accordance with at least one example described in the present disclosure. The method 1100 may be arranged in accordance with at least one example described in the present disclosure. The method 1100 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 1200 of FIG. 12, or another device, combination of devices, or systems.

The method 1100 may begin at block 1105 where the processing logic may perform, at the STA, an AIFS backoff.

At block 1110, the processing logic may perform, at the STA, a CSMA CW backoff.

At block 1115, the processing logic may perform, at the STA, a collision resolution operation.

At block 1120, the processing logic may send, at the STA, a frame after the collision resolution operation.

Modifications, additions, or omissions may be made to the method 1100 without departing from the scope of the present disclosure. For example, in some examples, the method 1100 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 12 illustrates a block diagram of an example communication system 1200 for CSMA with enhanced collision avoidance, in accordance with at least one example described in the present disclosure. The communication system 1200 may include a digital transmitter 1202, a radio frequency circuit 1204, a device 1214, a digital receiver 1206, and a processing device 1208. The digital transmitter 1202 and the processing device may receive a baseband signal via connection 1210. A transceiver 1216 may include the digital transmitter 1202 and the radio frequency circuit 1204.

In some examples, the communication system 1200 may include a system of devices that may communicate with one another via a wired or wireline connection. For example, a wired connection in the communication system 1200 may include one or more Ethernet cables, one or more fiber-optic cables, and/or other similar wired communication mediums. Alternatively, or additionally, the communication system 1200 may include a system of devices that may communicate via one or more wireless connections. For example, the communication system 1200 may include one or more devices that may transmit and/or receive radio waves, microwaves, ultrasonic waves, optical waves, electromagnetic induction, and/or similar wireless communications. Alternatively, or additionally, the communication system 1200 may include combinations of wireless and/or wired connections. In these and other examples, the communication system 1200 may include one or more devices that may obtain a baseband signal, perform one or more operations to the baseband signal to generate a modified baseband signal, and transmit the modified baseband signal, such as to one or more loads.

In some examples, the communication system 1200 may include one or more communication channels that may communicatively couple systems and/or devices included in the communication system 1200. For example, the transceiver 1216 may be communicatively coupled to the device 1214.

In some examples, the transceiver 1216 may obtain a baseband signal. For example, as described herein, the transceiver 1216 may generate a baseband signal and/or receive a baseband signal from another device. In some examples, the transceiver 1216 may transmit the baseband signal. For example, upon obtaining the baseband signal, the transceiver 1216 may transmit the baseband signal to a separate device, such as the device 1214. Alternatively, or additionally, the transceiver 1216 may modify, condition, and/or transform the baseband signal in advance of transmitting the baseband signal. For example, the transceiver 1216 may include a quadrature up-converter and/or a digital to analog converter (DAC) that may modify the baseband signal. Alternatively, or additionally, the transceiver 1216 may include a direct radio frequency (RF) sampling converter that may modify the baseband signal.

In some examples, the digital transmitter 1202 may obtain a baseband signal via connection 1210. In some examples, the digital transmitter 1202 may up-convert the baseband signal. For example, the digital transmitter 1202 may include a quadrature up-converter to apply to the baseband signal. In some examples, the digital transmitter 1202 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 1202.

In some examples, the transceiver 1216 may include one or more subcomponents that may be used in preparing the baseband signal and/or transmitting the baseband signal. For example, the transceiver 1216 may include an RF front end (e.g., in a wireless environment) which may include a power amplifier (PA), a digital transmitter (e.g., 1202), a digital front end, an IEEE 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1204) of the transceiver 1216 may be synchronized with the resource controller via the S-plane device, which may contribute to high-accuracy timing with respect to a reference clock.

In some examples, the transceiver 1216 may obtain the baseband signal for transmission. For example, the transceiver 1216 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1216 may generate a baseband signal for transmission. In these and other examples, the transceiver 1216 may transmit the baseband signal to another device, such as the device 1214.

In some examples, the device 1214 may receive a transmission from the transceiver 1216. For example, the transceiver 1216 may transmit a baseband signal to the device 1214.

In some examples, the radio frequency circuit 1204 may transmit the digital signal received from the digital transmitter 1202. In some examples, the radio frequency circuit 1204 may transmit the digital signal to the device 1214 and/or the digital receiver 1206. In some examples, the digital receiver 1206 may receive a digital signal from the RF circuit and/or send a digital signal to the processing device 1208.

In some examples, the processing device 1208 may be a standalone device or system, as illustrated. Alternatively, or additionally, the processing device 1208 may be a component of another device and/or system. For example, in some examples, the processing device 1208 may be included in the transceiver 1216. In instances in which the processing device 1208 is a standalone device or system, the processing device 1208 may communicate with additional devices and/or systems remote from the processing device 1208, such as the transceiver 1216 and/or the device 1214. For example, the processing device 1208 may send and/or receive transmissions from the transceiver 1216 and/or the device 1214. In some examples, the processing device 1208 may be combined with other elements of the communication system 1200.

FIG. 13 illustrates a diagrammatic representation of a machine in the example form of a computing device 1300 within which a set of instructions, for causing the machine to perform any one or more of the methods discussed herein, may be executed. The computing device 1300 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1300 includes a processing device (e.g., a processor 1302), a main memory 1304 (e.g., read-only memory (ROM), flash memory, dynamic random access memory (DRAM) such as synchronous DRAM (SDRAM)), a static memory 1306 (e.g., flash memory, static random access memory (SRAM)) and a data storage device 1316, which communicate with each other via a bus 1308.

Processing device 1302 represents one or more general-purpose processing devices such as a microprocessor, central processing unit, or the like. M ore particularly, the processing device 1302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also include one or more special-purpose processing devices such as an application specific integrated circuit (A SIC), a field programmable gate array (FPGA), a digital signal processor (DSP), network processor, or the like. The processing device 1302 is configured to execute instructions 1326 for performing the operations and steps discussed herein.

The computing device 1300 may further include a network interface device 1322 which may communicate with a network 1318. The computing device 1300 also may include a display device 1310 (e.g., a liquid crystal display (LCD) or a cathode ray tube (CRT)), an alphanumeric input device 1312 (e.g., a keyboard), a cursor control device 1314 (e.g., a mouse) and a signal generation device 1320 (e.g., a speaker). In at least one example, the display device 1310, the alphanumeric input device 1312, and the cursor control device 1314 may be combined into a single component or device (e.g., an LCD touch screen).

The data storage device 1316 may include a computer-readable storage medium 1324 on which is stored one or more sets of instructions 1326 embodying any one or more of the methods or functions described herein. The instructions 1326 may also reside, completely or at least partially, within the main memory 1304 and/or within the processing device 1302 during execution thereof by the computing device 1300, the main memory 1304 and the processing device 1302 also constituting computer-readable media. The instructions may further be transmitted or received over a network 1318 via the network interface device 1322.

While the computer-readable storage medium 1324 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1: Network Throughput and Collision Percentage

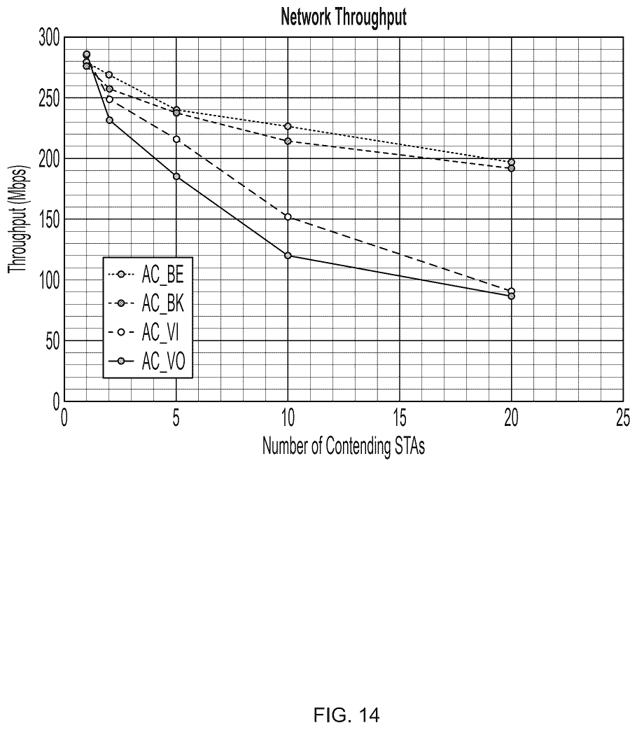

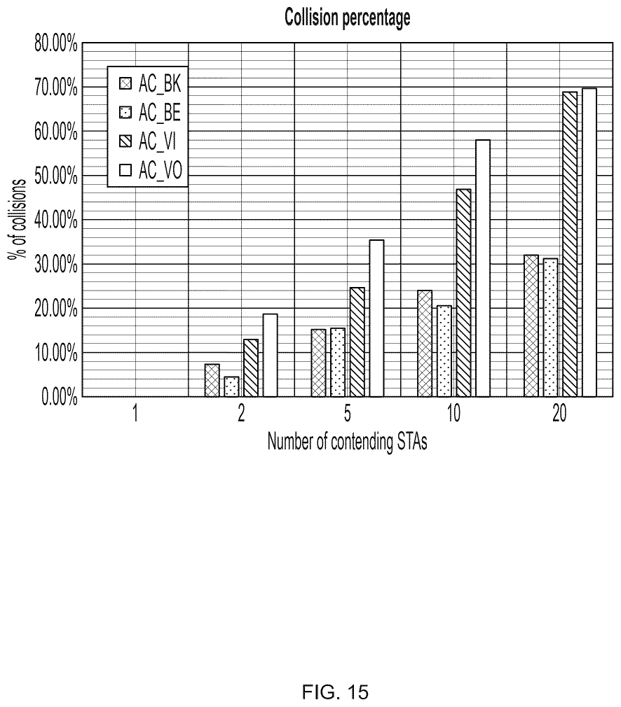

FIGS. 14 and 15 show how CSMA behaved under various network loads (number of contending devices). The simulation assumed a scenario with N STAs sending uplink traffic towards the access point (AP). N was varied between 1 and 20. Results are shown for the different access categories. Links assumed MCS7, 1 stream.

FIG. 14 shows how the throughput in M bps dropped as more devices contended in the network (i.e., number of contending STAs). For access categories AC_BE and AC_BK, the drop was from about 280 M bps, for 1 contending STA, to about 190 M bps, for 20 contending STAs. The drop was especially pronounced for ACs that have defined small contention windows, such as AC_VI and AC_VO (see Table 1). For access categories AC_VI and AC_VO, the drop was from about 280 MBps, for 1 contending STA, to about 90 M bps, for 20 contending STAs. For N=1, there were no collisions, and the throughput was maximal.

FIG. 15 shows the percentage of TXOPs that resulted in collisions for various access categories. When there was 1 contending STA, there were no collisions and the percentage of TXOPs that resulted in collisions was 0%. For 2 contending STAs, 5 contending STAs, 10 contending STAs, and 20 contending STAs, the percentage of TXOPs that resulted in collisions was lower for the access categories AC_BK and AC_BE when compared to the access categories AC_VI and AC_VO. For 2 contending STAs, 5 contending STAs, and 10 contending STAs, the percentage of TXOPs that resulted in collisions was lower for access category AC_VI when compared to access category AC_VO. For 20 contending STAs, the percentage of TXOPs that resulted in collisions was about the same for AC_VI and AC_VO.

The results in FIGS. 14 and 15 were obtained with an adaptive contention window, as described in the 802.11 standard.

### Example 2: Throughput as a Function of CW Max

To determine the effectiveness of adaptive CW, CW max was limited to various values, e.g., to a value below the ones specified in Table 1. For instance, setting CW max=CW min meant that the CW did not increase and maintained the same size, regardless of whether collisions were observed.

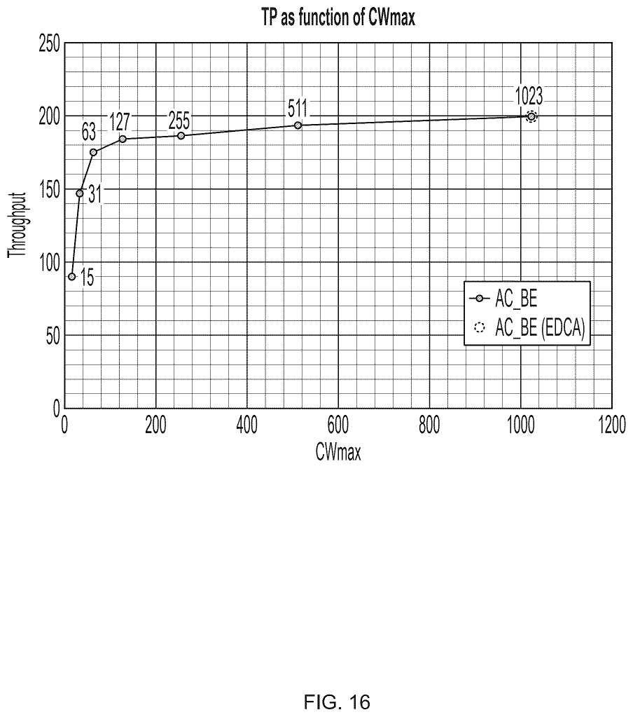

FIG. 16 shows how the network throughput in M bps was affected by limiting the value of CW max. In this simulation, 20 contending STAs were assumed. When the CW Max was limited to 15, the throughput was about 90 M bps. When the CW Max was limited to 31, the throughput was about 145 M bps. When the CW Max was limited to 63, the throughput was about 175 M bps. When the CW Max was limited to 127, the throughput was about 185 M bps. When the CW Max was limited to 255, the throughput was about 187 M bps. When the CW Max was limited to 511, the throughput was about 195 M bps.

Adjusting the CW in response to collisions-which is done in CSMA/CA-brought benefits. The EDCA value for CW max is circled in FIG. 16 (i.e., CW max value of 1023 which corresponded to a throughput of about 200 M bps). Values lower than the default value resulted in lower throughput. Therefore, adaptive CW enhanced throughput when compared to a situation in which the CW was not adjusted or was insufficiently adjusted.

### Example 3: Throughput as a Function of CW Max

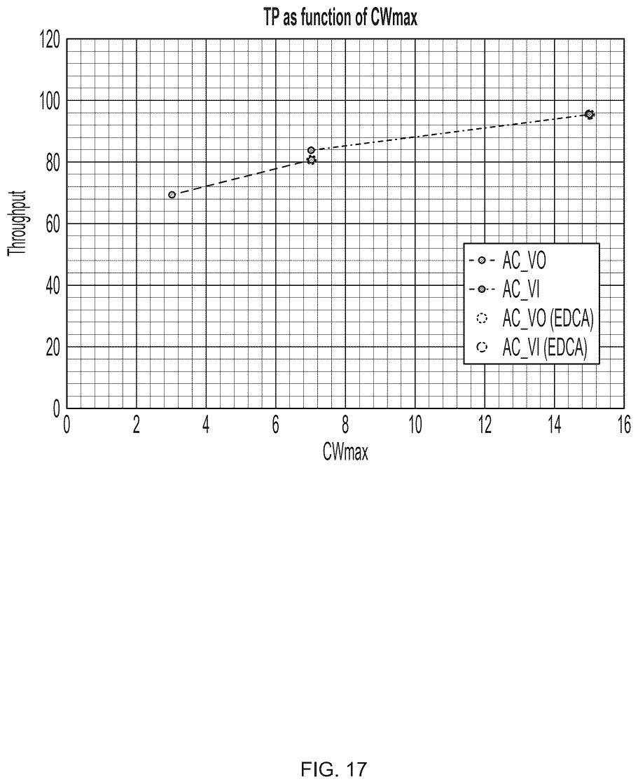

FIG. 17 shows the dependency for AC_VO and AC_VI. In this case, the allowed sizes for CW max are much more constrained (see Table 1). The default EDCA values are again circled. These choices of CW max improved performance over no adjustment, but the improvement was minimal.

### Example 4: Throughput as a Function of C W Max

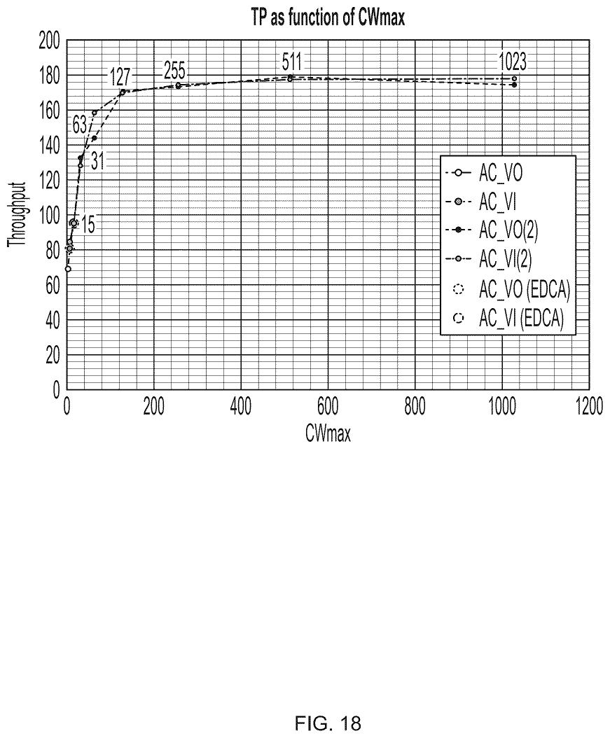

To see if AC_VO and AC_VI would benefit from larger possible values of CW max, the performance was examined when the CW max was increased beyond the value currently specified for AC_VO and AC_VI (Table 1). FIG. 18 shows how the performance was affected by these larger values. The performance in highly congested networks was much improved if AC_VO and AC_VI also used CW max values similar to AC_BE.

### Example 5: Fixed CW

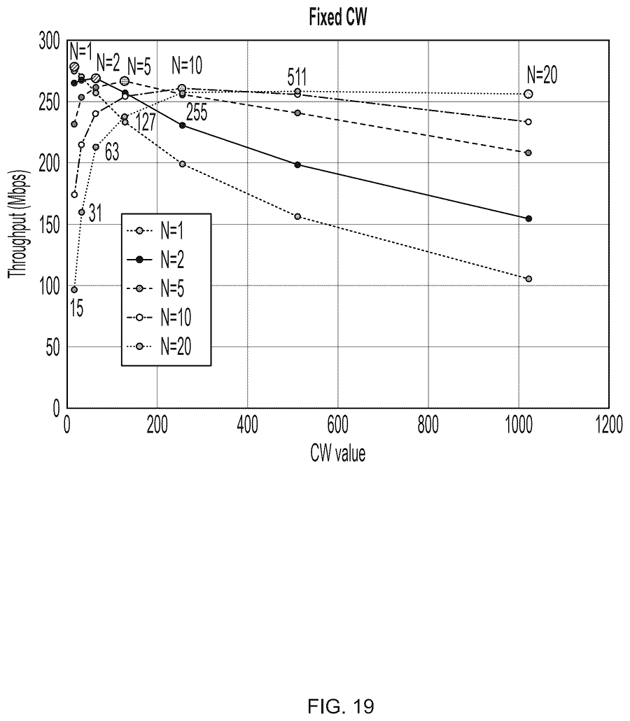

In FIG. 19, an alternative to adaptive CW was examined. In this simulation, all STAs used a fixed CW that did not get modified in response to collisions. The value of this fixed CW was varied between 15 and 1023.

As can be seen from FIG. 19, each level of network load (i.e. the number of contending STAs) has a value of the fixed CW that optimizes the performance. However, choosing a value for the fixed CW that is not suitable for the network load degraded performance because an excessive CW involved more MAC overhead.

### Example 6: Network Throughput

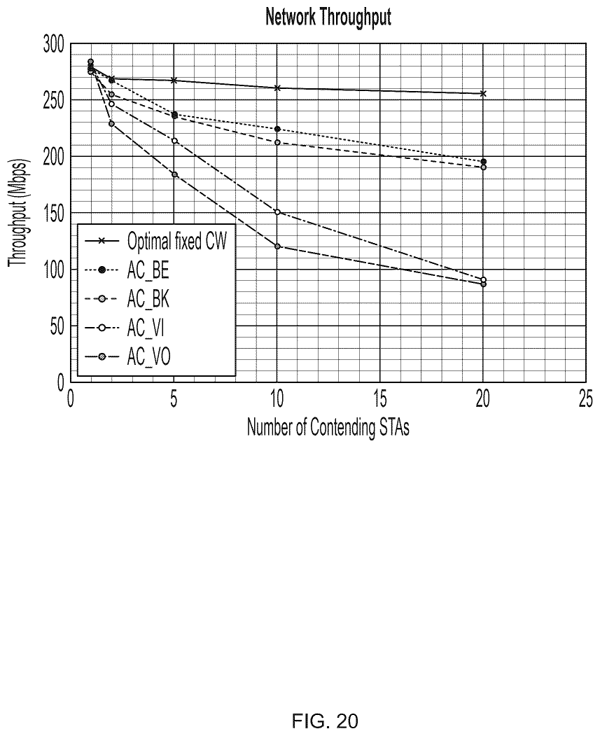

In principle, if the fixed CW was chosen optimally for each network load, this would result in higher performance than the current adaptive CW. FIG. 20 compared such hypothetical optimal performance (picking the optimal points from FIG. 19) with the performance of legacy CSMA. It can be seen that such a mode significantly outperformed CSMA for higher network loads. However, it may be difficult in practice to deploy such a mechanism based on fixed CW because finding the optimal value may not be straightforward. Moreover, such a mechanism may not be backwards compatible with deployed CSMA-based systems.

### Example 7: Conclusion

Collisions remained a problem within CSMA, even with a contention window that was adaptive to medium conditions (i.e. collisions). This was the case for access categories with a low value for CW max such as AC_VI and AC_VO.

### Example 8: Percentage of Collisions

The number of “collision resolution” rounds used can be determined.

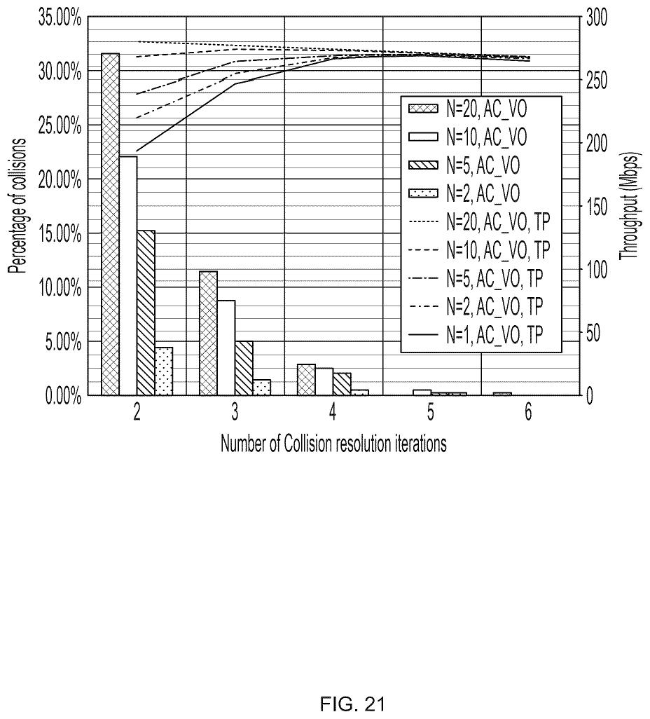

FIG. 21 shows the percentage of collisions (bar graph) as a function of the number of secondary contention rounds (traffic is of access category AC_VO). As expected, the number of collisions diminished with the number of rounds.

Additional rounds added a small amount of overhead to the total transmission time. FIG. 21 also showed the throughput as a function of the number of rounds. The trendlines varied depending on the amount of contending STAs. For low congestion (e.g. N=1 as an extreme example), the throughput diminished slightly with each additional round. For cases with contention, the optimal number of rounds appeared to be around 3 or 4.

### Example 9: Network Throughput for 3 and 4 Iterations

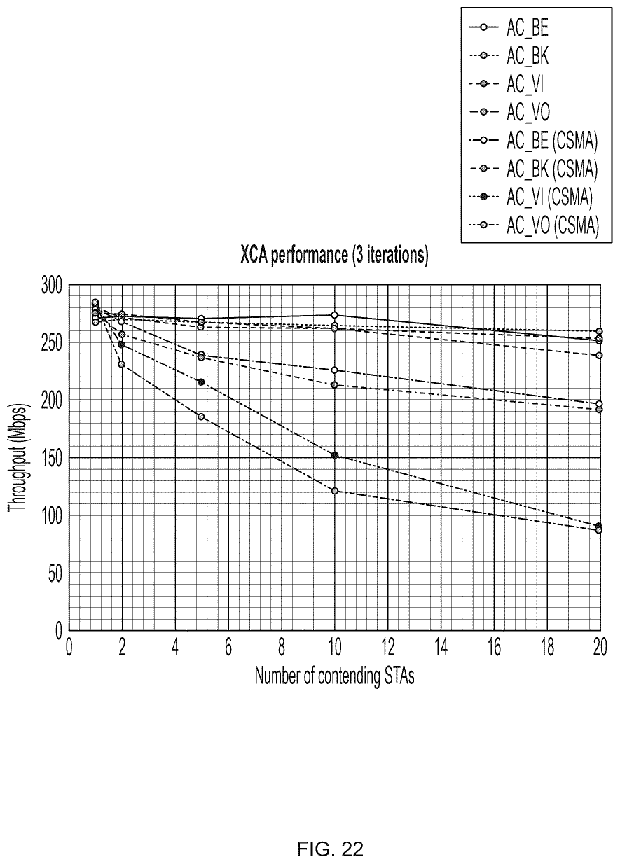

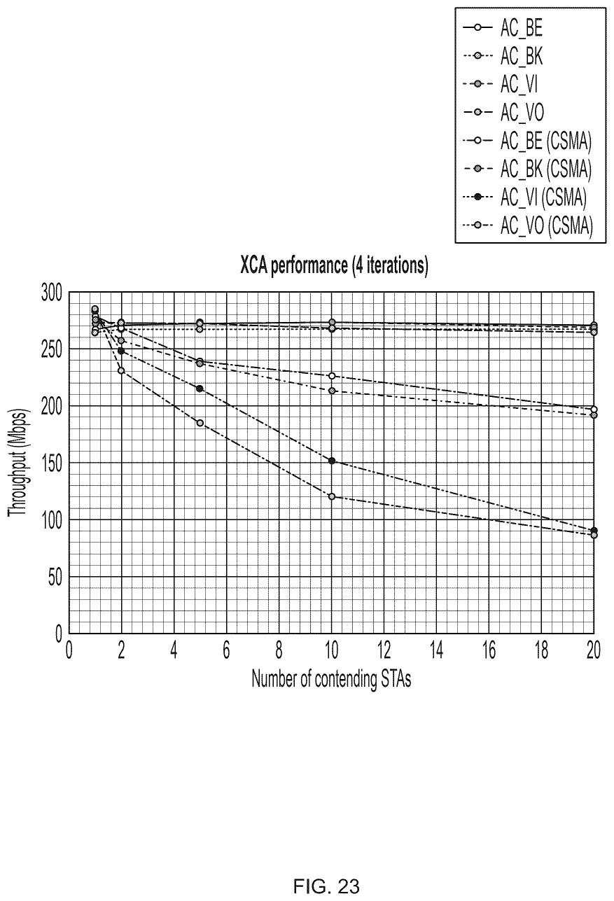

FIGS. 22 and 23 show the network throughput for 3 and 4 iterations and compare it with the throughput of legacy CSMA.

From FIGS. 22 and 23, we can see that the impact of collisions on throughput is significantly reduced. In fact, for 4 iterations, the network throughput showed almost no dependency on the number of contending STAs, meaning that collisions no longer played a role.

The only price to pay was a slightly lower throughput for lightly loaded networks (i.e. networks where the number of collisions would naturally be low). This small reduction came from the additional time overhead of the collision resolution. However, in the simulations, the throughput was better with collision resolution for values of N as low as N=2.

### Example 10: Number of Collisions

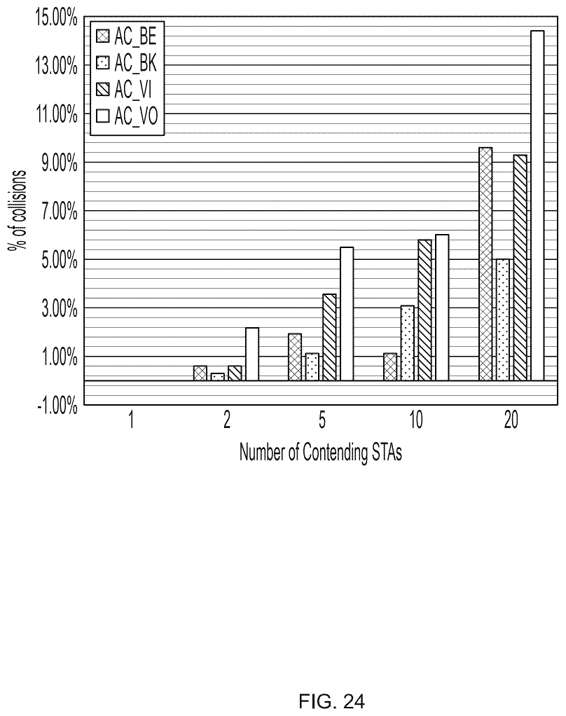

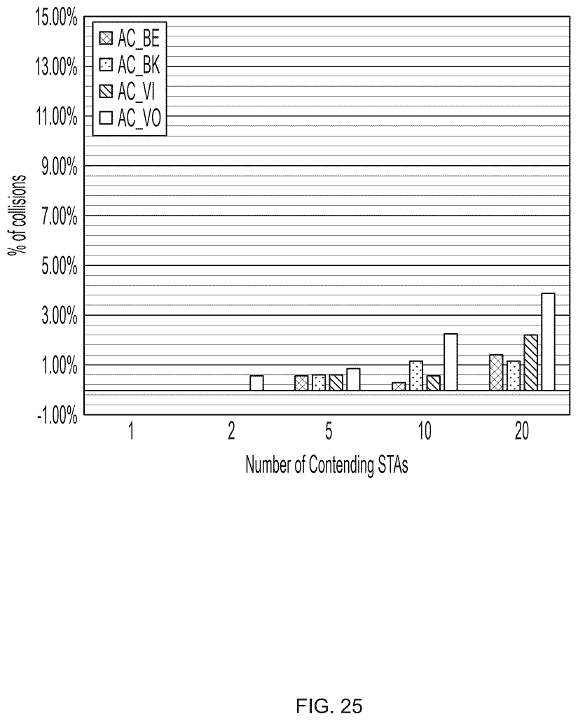

The number of collisions (as a percentage of TXOPs in which a collision occurs) is shown in FIGS. 24 and 25. FIGS. 24 and 25 explicitly confirm that the number of collisions was significantly reduced, and that collisions were almost non-existent for 4 iterations.

### Example 12: Conclusion

An enhanced CSMA/CA method provides for an extra round of collision resolution before transmission of the data or management frame. Such a method reduced the probability of collision in a highly congested environment.

### Example 13: CSMA with Enhanced Collision Avoidance for Low-Latency Traffic

The use of enhanced collision avoidance for enhanced latency was determined. The environmental setup included a network saturated with AC_BE traffic. The latency of a number of low-rate AC_VO traffic streams in such an environment (N_{LL}=1-10) was determined. The simulation conditions included 1 AP, 10 STAs with full-buffer UL AC_BE traffic; N_{LL}=1, 2, 5 and 10 LL traffic streams; 2 M bps CBR; 1500-byte packets; MCS7, N_{SS}=1 PHY rate; and EDCA, CSMA, ACK modeled as per IEEE 802.11. The 95^{th} percentile and latency cumulative distribution function (CDF) were analyzed.

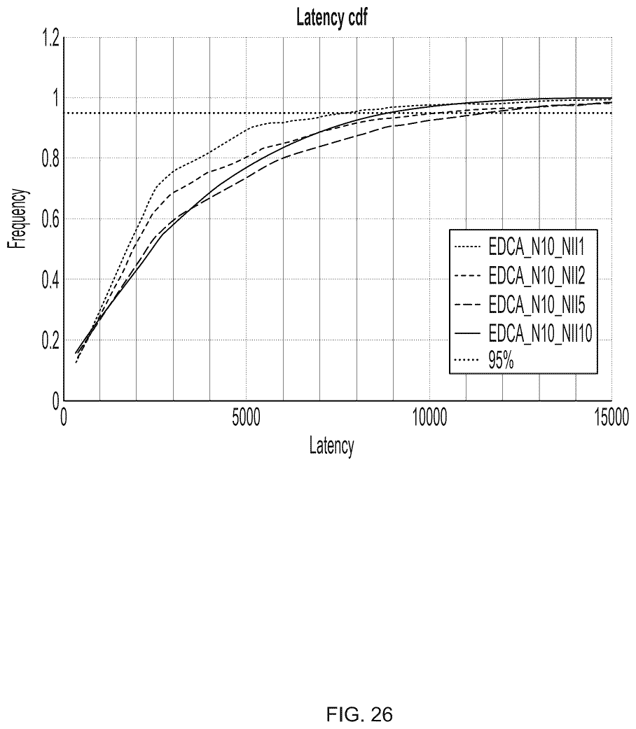

In case 1, as illustrated in FIG. 26, LL traffic was sent as AC_VO. The latency of LL was affected by collisions/contention with AC_BE even when N_{LL}=1. When the number of LL increased, additional collisions between LL further degraded latency.

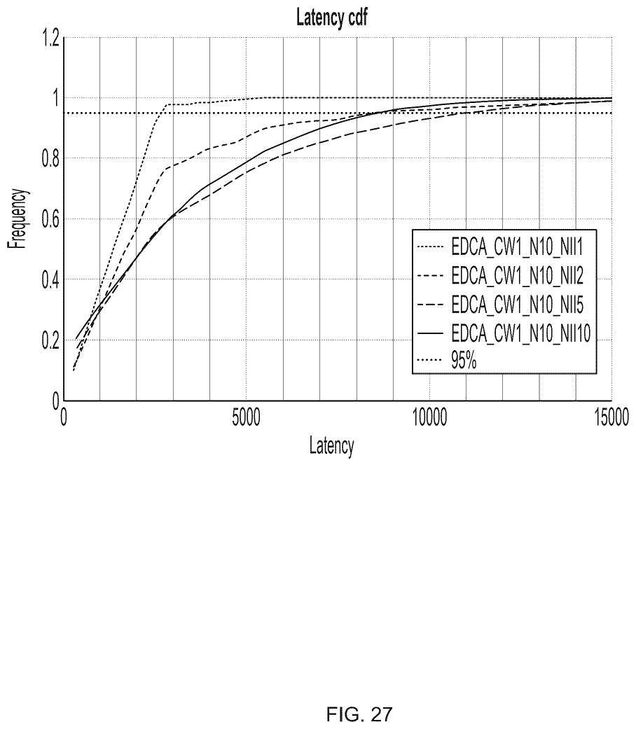

In case 2, as illustrated in FIG. 27, LL traffic was sent in a new AC with smaller CW (CWₘᵢₙ=1). LL got priority access. A small probability of collisions with AC_BE remained. When the number of LL increased, collisions between LL degraded latency.

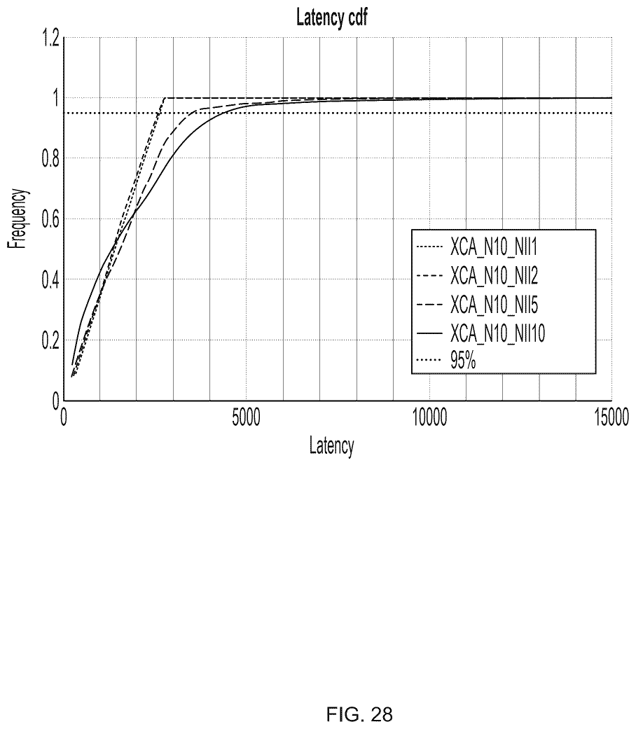

In case 3, as illustrated in FIG. 28, LL traffic was sent in new AC with smaller CW (CWₘᵢₙ=0) and additional collision avoidance. LL got absolute priority access. No collisions with AC_BE. Latency was determined by the max length of the AC_BE PPDUs. When the number of LL increased, collisions between LL were mostly avoided, causing minimal impact on latency of LL.

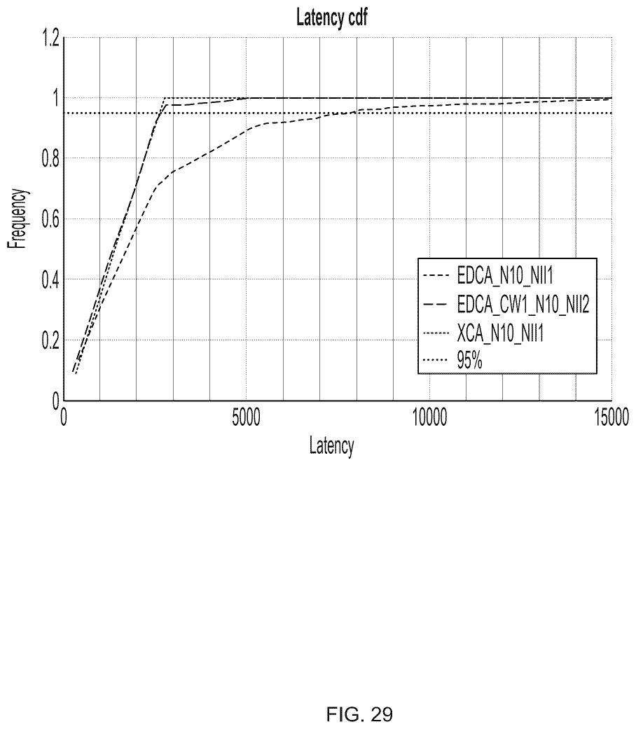

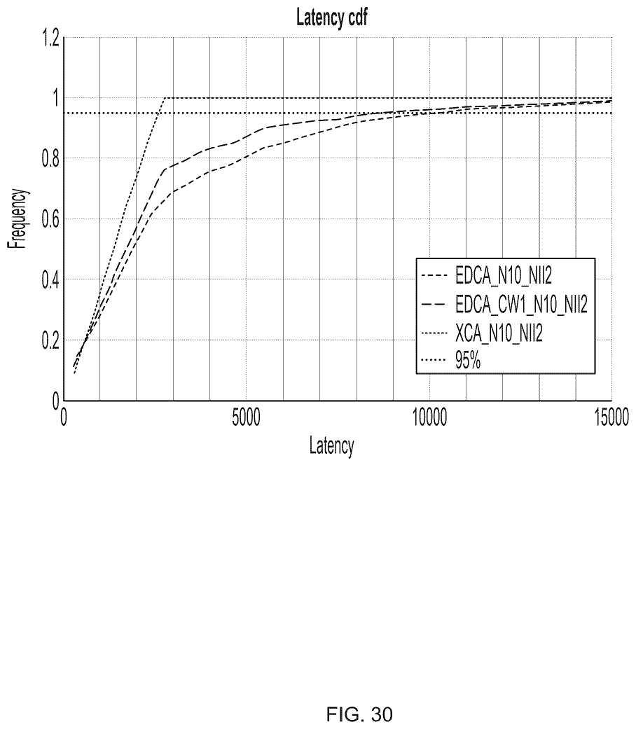

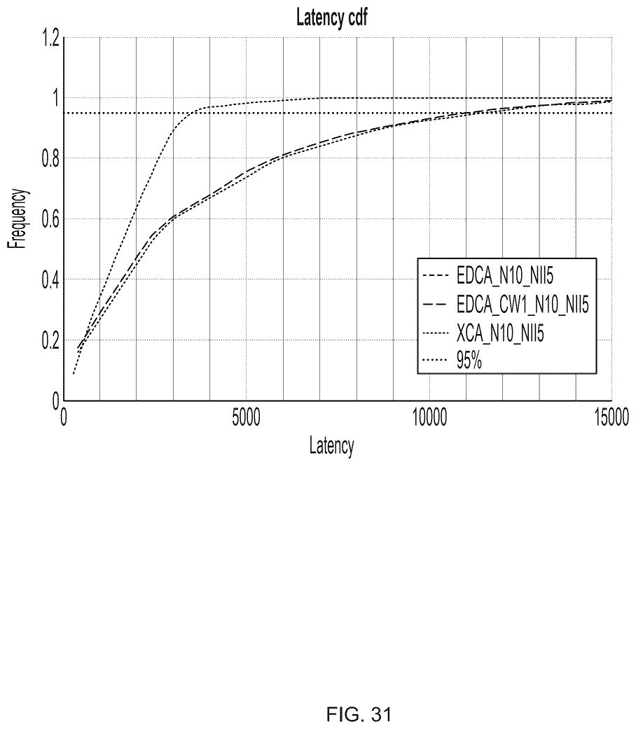

As illustrated in FIG. 29, the latency CDF for N_{LL}=1 is shown. CSMA with enhanced collision avoidance had a reduced latency at the 95^{th} percentile. As illustrated in FIG. 30, the latency CDF for N_{LL}=2 is shown. CSMA with enhanced collision avoidance had a reduced latency at the 95^{th} percentile. As illustrated in FIG. 31, the latency CDF for N_{LL}=5 is shown. CSMA with enhanced collision avoidance had a reduced latency at the 95^{th} percentile.

A summary of the 95^{th} percentile latency (in msec) is provided in Table 2:

TABLE 2
95^{th} percentile latency

| | Number of LL Traffic Streams | | | |
|---|---|---|---|---|
| | 1 | 2 | 5 | 10 |
| Case 1 | 7.79 | 10.28 | 11.47 | 8.79 |
| (AC_VO) | | | | |
| Case 2 | 2.68 | 8.70 | 11.06 | 8.68 |
| (CW min = 1) | | | | |
| Case 3 | 2.65 | 2.60 | 3.56 | 4.34 |
| (CW min = | | | | |
| 0 + CA) | | | | |

In summary, LL traffic sent in new AC and with additional collision avoidance significantly improved 95^{th} percentile latency for any number of LL services. Using the new AC avoided collisions and contention with AC_BE. Collisions between LL may still occur. Using enhanced collision avoidance avoided collisions within the LL AC. Eliminating both sources of collisions led to significant improvement in latency for LL. Not just the 95^{th} percentile was improved—the entire CDF was better with enhanced collision avoidance.

The LL traffic streams affected overall network capacity. Case 3 had a lower impact on network throughput. Total Network TP in M bps is provided in Table 3:

TABLE 3
Impact on network throughput

| | Number of LL Traffic Streams | | | |
|---|---|---|---|---|
| | 1 | 2 | 5 | 10 |
| Case 1 | 205.92 | 189.60 | 151.25 | 96.60 |
| (AC_VO) | | | | |
| Case 2 | 216.06 | 204.39 | 154.62 | 96.52 |
| (CWmin = 1) | | | | |
| Case 3 | 215.22 | 204.28 | 175.90 | 124.48 |
| (CWmin = | | | | |
| 0 + CA) | | | | |

A 2 M bps LL stream with 1500-byte packets generated a packet every 6 msec. Assuming ˜250 usec to transmit such a packet (+BO, ACK, SIFS, . . . ), N_{LL}×250 μsec of airtime was used every 6 msec-without accounting for collisions. For N_{LL}=10, this means roughly 2.5 msec every 6 msec, meaning about half of the initial Network capacity-depending on amount of collisions

### Example 14: Network Throughput and Latency for Different Short Signals

Network throughput was evaluated as a function of number of contending devices (transmitting AC_VO). The simulation details included: 1 AP, 10 STAs with full-buffer UL AC_BE traffic; N_{LL}=1, 2, 5 LL traffic streams; 2 M bps CBR; 1500-byte packets; MCS7, N_{SS}=1 PHY rate; EDCA, CSMA, ACK, . . . modeled as per IEEE 802.11.

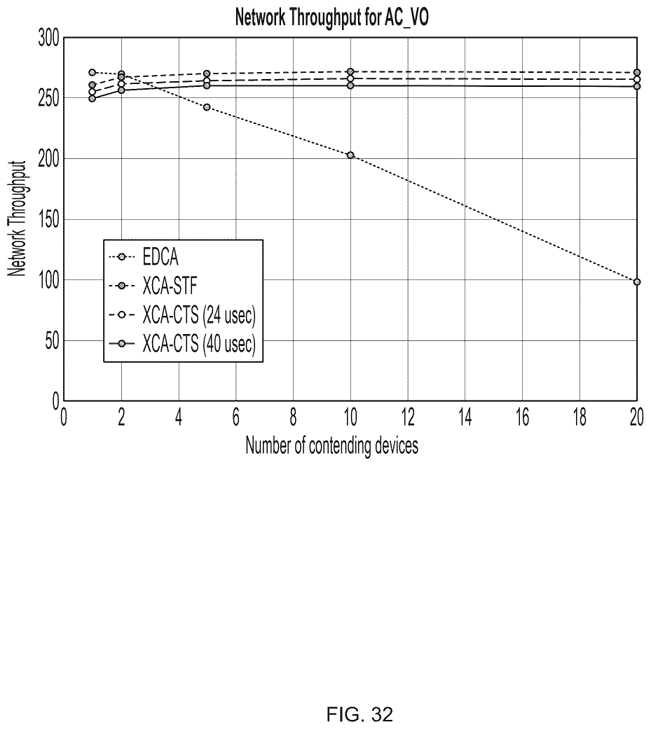

As illustrated in FIG. 32, using CTS as the reservation signal (e.g., short signal) incurred minor extra overhead, but performed similarly to the original method in avoiding collisions. Legacy EDCA had high residual collision rate in highly congested networks Duration of CTS (min 24 usec, max 40 usec) had minor impact on network throughput.

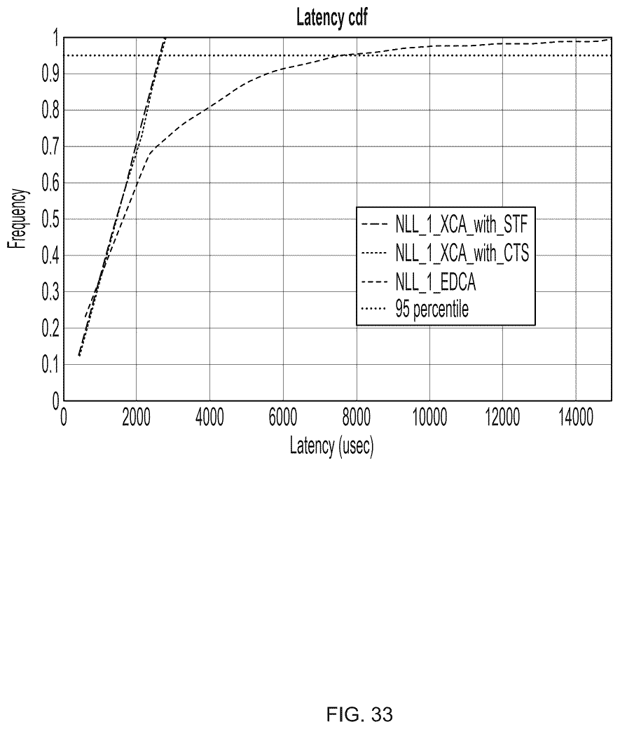

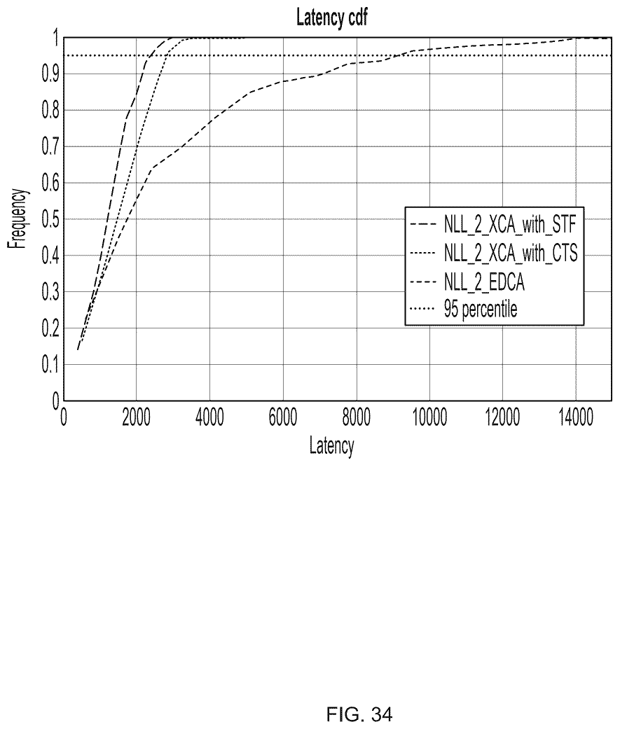

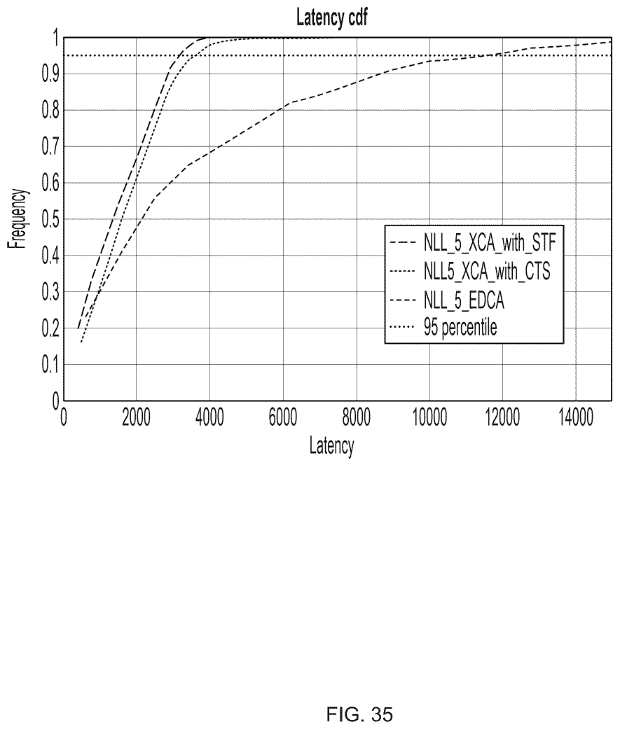

Thus, the reservation signal may be replaced by CTS without significantly affecting these results. Enhanced EDCA significantly outperformed EDCA. Evaluated for various values of N_LL (#of LL devices needing the new latency values). As illustrated in FIG. 33, for N_{LL}=1, enhanced collision avoidance outperformed legacy EDCA. As illustrated in FIG. 34, for N_{LL}=2, enhanced collision avoidance outperformed legacy EDCA. As illustrated in FIG. 35, for N_{LL}=5, enhanced collision avoidance outperformed legacy EDCA.

A summary of the results is provided in Table 4.

TABLE 4
95 percentile values

| | | Enhanced Collision | |
|---|---|---|---|
| | | Avoidance (XCA) | |
| N_LL | EDCA | STF | CTS |
| 1 | 7.87 | 2.79 | 2.84 |
| 2 | 9.78 | 2.81 | 2.95 |
| 5 | 12.11 | 3.30 | 3.71 |

Enhanced EDCA may be achieved by a collision avoidance phase in the contention where the reservation signal is a “regular” CTS. The method achieved both collision reduction and latency improvement.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A station (STA), comprising:
a processing device operable to:
perform, at the STA, an arbitration inter-frame spacing (AIFS) backoff;
perform, at the STA, a carrier-sense multiple access (CSMA) contention window (CW) backoff;
send, at the STA, a first short signal when reaching a CSMA CW backoff end;
perform, at the STA, a first short backoff after sending the first short signal; and
send, at the STA, a frame after an nth short signal has been sent and an nth short backoff has occurred, wherein n is an integer greater than or equal to 2.

2. The STA of claim 1, wherein the processing device is further operable to:
send, at the STA, a second short signal after the first short backoff; and
perform, at the STA, a second short backoff after sending the second short signal.

3. The STA of claim 2, wherein the processing device is further operable to:
send, at the STA, a third short signal after the second short backoff; and
perform, at the STA, a third short backoff after sending the third short signal.

4. The STA of claim 1, wherein n is equal to 4.

5. The STA of claim 1, wherein the processing device is further operable to:
terminate, at the STA, medium contention when the STA detects a clear channel assessment (CCA) value that is greater than a threshold CCA value.

6. The STA of claim 1, wherein the first short signal is one or more of: 8 microseconds, 24 microseconds, or 40 microseconds.

7. The STA of claim 1, wherein the first short signal is one or more of a legacy short training field (L-STF) signal or a clear-to-send (CTS) signal.

8. The STA of claim 1, wherein the first short backoff has a duration that is less than the AIFS backoff.

9. The STA of claim 1, wherein the processing device is further operable to:
skip, at the STA, transmission in a first slot after transmission of the first short signal to facilitate transmit/receive (Tx/Rx) turnaround.

10. A method, comprising:
performing, at a station (STA), an arbitration inter-frame spacing (AIFS) backoff;
performing, at the STA, a carrier-sense multiple access (CSMA) contention window (CW) backoff;
sending, at the STA, a first short signal when reaching a CSMA CW backoff end;
performing, at the STA, a first short backoff after sending the first short signal; and
sending, at the STA, a second short signal after the first short backoff; and
performing, at the STA, a second short backoff after sending the second short signal; and
sending, at the STA, a frame after the second short backoff.

11. The method of claim 10, further comprising:
terminating, at the STA, medium contention when the STA detects a clear channel assessment (CCA) value that is greater than a threshold CCA value.

12. The method of claim 10, wherein the first short signal is one or more of: 8 microseconds, 24 microseconds, or 40 microseconds.

13. The method of claim 10, wherein the first short signal is one or more of a legacy short training field (L-STF) signal or a clear-to-send (CTS) signal.

14. The method of claim 10, wherein the first short backoff has a duration that is less than the AIFS backoff.

15. A station (STA), comprising:
a processing device operable to:
perform, at the STA, an arbitration inter-frame spacing (AIFS) backoff;
perform, at the STA, a carrier-sense multiple access (CSMA) contention window (CW) backoff;
perform, at the STA, a collision resolution operation; and
send, at the STA, a frame after the collision resolution operation.

16. The STA of claim 15, wherein the collision resolution operation includes sending one or more short signals and performing one or more short backoffs.

17. The STA of claim 16, wherein the one or more short signals are one or more of: 8 microseconds, 24 microseconds, or 40 microseconds.

18. The STA of claim 16, wherein the one or more short signals are one or more of a legacy short training field (L-STF) signals or a clear-to-send (CTS) signals.

19. The STA of claim 16, wherein the one or more short backoffs have a duration that is less than the AIFS backoff.

20. The STA of claim 16, wherein the processing device is further operable to: terminate, at the STA, medium contention when the STA detects a clear channel assessment (CCA) value that is greater than a threshold CCA value.
